(19) United States
(12) Patent Application Publication
(10) Pub. No.: US 2014/0028028 A1
(43) Pub. Date: Jan. 30, 2014

(54) Free-flow hydro powered turbine system

(71) Applicant: Clarence Edward Frye, Blountville, TN (US)

(72) Inventor: Clarence Edward Frye, Blountville, TN (US)

(21) Appl. No.: 13/913,446

(22) Filed: Jun. 9, 2013

Related U.S. Application Data
(63) Continuation-in-part of application No. 12/658,761, filed on Feb. 12, 2010, now abandoned.
(60) Provisional application No. 61/272,131, filed on Aug. 19, 2009.

(51) Int. Cl. F03B 13/10

(52) U.S. Cl. CPC F03B 13/10
USPC 290/54

(57) ABSTRACT

A power plant using an impulse turbine and generator in combination to generate electricity, driven by the kinetic energy of an ocean stream which enters and passes through a system of conduits which manage volume, velocity and mass in a water tight structure, which houses the turbine inside on a working floor surface. The force of the stream enters transits and departs the system without any interruption in the flow, except when the turbine is in non-operational status. There are no moving parts except for two manual valves placed before the entry and exit port of the Pelton impulse turbine. The plant structure is held in fixed position at any depth relative to the current flow and its hydrostatic head. This capacity of this enablement is equivalent to any land based hydro-electric power plant. The magnitude of the current imposes no limit on the size or location for this invention.

### CROSS REFERENCE TO RELATED US PATENT APPLICATIONS

This application is a continuation in part of application Ser. No. 12/658,761 filed Feb. 12, 2010.

### CROSS REFERENCE TO RELATED PATENTS

U.S. Pat. No. 8,234,861, FREE FLOW HYDRO-POWERED HYDRAULIC RAM, issued Sep. 10, 2012.

### CROSS REFERENCE TO RELATED PROVISIONAL PATENTS

U.S. Provisional Patent Application No. 61/743,496, Free Flow Wind Powered Prime Mover and Compressed Air Energy Storage Cell as a Prime Mover of Beneficial Workload Components.

### FEDERALLY SPONSORED RESEARCH RELATED APPLICATIONS

N/A

### THE NAMES OF THE PARTIES TO A JOINT RESEARCH AGREEMENT

N/A

### INCORPORATION BY REFERENCE OF MATERIAL SUBMITTED ON A COMPACT DISC

N/A

### FIELD OF THE INVENTION

The present invention relates to an off shore Hydro Power Plant for generating electricity, and more particularly to the described means for extracting kinetic energy from ocean currents. The surrounding ocean waters are an eternal kinetic energy pool. Acting as the prime mover, these waters and the accompanying ocean currents are always ready to power the high performance Pelton Wheel impulse turbines and in turn the generators which produce electrical current in this embodiment.

Ocean currents are moving bodies (rivers) of water. This enablement extracts/converts the kinetic energy derived from ocean currents and mass (weight) at a depth to its best form, electricity.

This invention is best compared with existing hydro-electric power dams which produce currents at a lower unit cost than land based fossil fuel fired power generators.

The enablement relates to a completely enclosed electrical power generation plant, standing alone as a structure, on a station opposing a constantly flowing ocean stream of kinetic energy. The force of this moving mass is the prime mover to drive one or more Pelton Wheel impulse turbines to generate a nearly infinite amount of low cost electrical power or for other useful purposes. This stream of water flowing through the enclosed power plant can be turned on or off, as if it were a water faucet in a kitchen. The ocean, is the reservoir of this infinite body of free flowing kinetic energy, and only requires this faucet to be turned on to be a prime mover. There is not a single moving part between the ocean reservoir and the cutoff valve on the power plant operating floor. This method, as an operative means is simple, elegant and profound in its ramifications.

Hydrospace Off shore Sites: Ocean Currents & Winds as Kinetic Energy Pools.
(a) These rivers of seawater and atmospheric air are open channel flows of matter which observe the natural laws of physics. Both are fluids, water being non-compressible, atmospheric air being compressible.
(b) The best existing technologies, as means to extract energy include:

(1) Giant wind driven turbine/generators sitting atop pylons anchored on the sea floor. These may include an array of these turbines which are situated over a large area and are often described as wind farms. The wind velocity (speed) encounters the turbine blades as a resisting surface and in turn cause said blades to rotate and drive a generator of electricity. The weather at the moment determines the wind speed as a useful force. This force is what acts upon the turbine to effect rotation torque.

What force comes by is what is available to do useful work. There is no acceleration by reason of the hydraulic dynamics provided by a closed circuit, as in the case of this embodiment.

(2) Underwater turbine/generators of electricity literally swim within the ocean current (river) in multiple numbers, over an extended area, each one being attached to the sea floor. As is the case for the windmill turbines, the flowing stream encounters the blades in response to the applied force. The sea water currents are more or less running at a constant speed or velocity and temperature over time. In the case of these devices, what flows by is what acts upon the turbine blades to provide torque to generate electricity. There is no acceleration by reason of the hydraulic dynamics provided by a closed circuit.

(3) My invention, in its best use embodiment (Pelton Wheel Turbine) and its alternative embodiment as a supercharged atmospheric air flow, introduces the flows of kinetic energy into, through and out of a conduit system that accelerates and regulates both velocity and volumes. Cones/frustums having the shape of nozzles accelerate the flow, whatever enters in one second goes out the exit point at one second, as a net force, unless the conduit includes a cutoff valve as a means to bring it to a complete stop when closed.

Extracting Energies from Hydrospace/Atmosphere

In a larger sense the field of my invention is the physical and environmental character of the location, the infrastructure needed to support the distribution of energy products, and the interplay of multiple governmental and private interests as a developmental and operating project. The technology disclosed by my invention, as a means to extract an almost infinite energy source is one thing. To bring it into an operating reality is quite another. This can be brought into fruition in the following manner:

(a) Development on the scale that can assure effective use of my invention's technology and to bring it on line requires a massive capital expenditure. The first act must involve off-shore surveys of practical sites followed by conceptual development of power plant facilities and up link output distribution to on-shore grid connections to private regional power producers. The planners should be private producer operators of power plant systems or governmental agencies such as the Tennessee Valley Authority or other such agencies. The off shore sites are government property, to be leased under development/operating permits. The sites are both federal and state owned along seashores having ocean streams, such as the Gulf Stream. These are infinite pools of kinetic energy.

### BACKGROUND OF THE INVENTION

Our Earth is a water planet. Within the oceans are moving masses of energy as ocean spanning currents with crushing pressure, due to depth. If this energy could be mastered, the benefits are incalculable. These renewable energy sources are powerful beyond belief and will be with us long as the Earth exists.

Winds of high constancy blow with great regularity over the ocean. Those winds, along with the salinity balance of the ocean, have the effect of producing currents which are effectively, rivers at sea. The northwest and southeast trade winds of the two hemispheres are the mainsprings of the ocean's surface current circulation. In the Atlantic and Pacific oceans, the two trade winds drive an immense body of water westward over a width of some 50 degrees of latitude, broken only by the narrow belt of the east-going equatorial counter-current, which is found a few degrees north of the equator.

Currents of over 3.5 mph are confined to very restricted regions. In the Straits of Florida, the Gulf Stream, a moving body of water within the Atlantic Ocean, reaches depths of 2,000 feet and moves at the rate of about 6 miles per hour.

The Gulf Stream flows at a substantial speed for some 400 miles. It hits peak velocity off Miami, where it is about 45 miles wide and 1,500 feet deep. There, the current has reached a speed of as much as 7.75 mph in its narrow central axis. Although the peak current velocity of the Gulf Stream may at times, exceed 7 mph in its narrow axis off of Miami, the most likely velocities for those turbines placed in its central axis would be between 4.75 and 6 mph. Ocean Passages of the World (published by the Hydrographic Department of the British Admiralty, 1950), lists 14 ocean currents that exceed 3 knots (3.45 mph), many of which are in the open ocean. Any of these currents would provide a suitable placement for this enablement.

The present conventional method of generating power is the hydro-electric generating dam, which has been around for well over a century, without any major conceptual breakthroughs. At this time, 20 percent of the world's electricity is generated by surface water dropping in elevation and flowing through turbines to produce hydro-electric power.

From the force of falling water, a turbine of conventional hydro-electric dams generates energy in the following manner:

a. A flowing source of water down-hill from a gravitational pull or from natural forces as currents, which flow into a turbine;
b. Water strikes and turns the blades of a turbine which rotates the shaft of a power generator;
c. The shaft rotation through the generator creates a flow of electrons as an electrical current;
The electrical current is processed through a transformer to produce a voltage suitable for transmission onward;
The water is discharged as spent water flow;

However, based upon current technology, hydro-electric dams are enormously costly to build and there are many additional obstacles preventing the successful use of impounded water for hydroelectric purposes include the following:

(a) Damming of the flowing water is prohibitively expensive;
(b) It is often impossible to locate in a particular location because of soil conditions;
(c) It may be impossible to locate because of geographic conditions;
(d) It may be impracticable because of navigational needs for the flowing water;
(e) Deep layers of alluvial soil overlaying impossibly deep bedrock, may make construction of foundations for dams totally impractical;
(f) Broad flat valleys, such that small rises in water level would inundate huge acreages of valuable land, and small drops in water level would lay bare large areas of mud flats;
(g) Related to the above, lack of nearby mountain ridges between which dams could be built may prevent their construction.

### BRIEF SUMMARY OF THE INVENTION

The present invention avoids all of the above problems of constructing additional land based systems. There is no practical limit on the number of these generating plants which can be operated in ocean currents around the Earth. No water is consumed. Instead, it merely passes through this enablement, moving the turbines and generating electricity in the process. This is an unlimited energy source for mankind for as long as the World exists.

This enablement relies on (1) the incompressibility of water and its mechanical properties, and (2) natural forces that assure the intake of water into the Penstock leading to the Pelton impulse turbine and (3) the motive force of a free flowing stream moving through a Jet Pump conduit which intakes the flow from the ocean stream, accelerates its velocity, supplies the Penstock conduit and moves the system's combined flow onward as an exhausting function to the downstream ocean current.

This system transforms kinetic energy into mechanical energy by rotating an impulse wheel turbine, which in turns rotates the shaft of a generator. Mechanical energy is the link, which applies hydraulic energy to a generator workload and causes a flow of electrons. The result is the flow of electrons by extraction from eternally flowing ocean currents.

This enablement is the marine version of land based, gravity fed hydro-electric power plants, but it also is evolutionarily related to the river turbine line of inventions that have sought to harness currents in rivers throughout the world.

Many efforts were made in the late 1800's and early 1900's to harness the flowing currents of rivers without using dams. These river current motors were supposed by their inventors to recover energy from the velocity of the moving currents of water, and to convert this energy to some other more useful form. The driving of a generator of electricity was one commonly envisioned form.

The turbine and electricity generator and ancillary items are commercially available items, either as production or as custom designed facility installations. The Pelton Wheel Turbine comes in many sizes and variations. The largest one, with its electricity generating capacity, was said to produce 800 Mega watts. This turbine type traces its design origin back to the 1870s.

The Pelton Wheel is an impulse turbine which is among the most efficient types of water turbines. It extracts energy from the impulse (momentum) of moving water like the traditional overshot water wheel. Pelton's paddle geometry was designed so that when the rim runs at ½ the speed of the water jet, the water leaves the wheel with very little speed, extracting almost all of its energy, and allowing for a very efficient turbine. It is designed so that nearly all of the pressurized water momentum is transferred to the turbine. Thus, a very small percentage of the water's original kinetic energy will still remain in the water. This allows the bucket to be emptied at the same rate it is filled, thus allowing the water flow to continue uninterrupted.

Pelton wheels are made in all sizes and together with electricity generating systems and power plant packages. This coupled with an inexhaustible water supply at a relatively constant flow rate makes them the best options from a power plant designer viewpoint. The unique property of this enablement is that it lets a designer start from a required electrical power output and then figures the kinetic energy needed in cubic meters of flow per second, to drive the generating system and then size the turbine and supporting water supply accordingly. This is the reverse situation faced with static land based hydro dam power sites, where everything is a tradeoff. The Pelton Wheel and electrical generating systems are a good fit for this enablement, which requires placement at a depth in an ocean current, utilizing this inexhaustible pool of kinetic energy.

The operating environment of this enablement offers, freedom of design and avoids the restraints of static locations

Because this embodiment would operate best under steady loads and its operating costs would be extremely low, the power it produces could be far in excess of that required by the grid during peak hours and the excess could be used to produce off-site energy in other forms. The amount of hydrogen that can be produced by this method is directly proportional to the amount of electricity used.

Every kilowatt-hour of electricity that is generated by water, wind, and other renewable-energy sources can replace the same unit of electricity that is presently being generated by burning fossil fuels.

In summary, this enablement has a constantly flowing water supply as a prime mover (W1) and consumes no matter, as it transforms energy from an infinite renewable source. It is readily replicated and produced for volume energy needs. This invention ensures a relatively inexpensive method of producing energy, without consuming any fuel or non-renewable resource, in a completely environmentally friendly manner. These are its principal advantages over other fossil-based systems in present use. This enablement is a new Paradigm which utilizes natural forces of the universe to bring a new method of energy generation to the World for all of its many uses.

### DISCUSSION OF PRIOR ART

The prior art discloses devices that are submerged in a body of water and operated as specific integrated apparatus, said objects being for the purpose of transforming kinetic energy to a form useable for beneficial purposes. These objects are not comparable to our enablement as to their physical configuration, their operative devices or the means used to harness the stream's kinetic energy as a prime mover of devices, which are the integral parts of such art utilized in this enablement.

Man has always seen moving water as a means to do beneficial work. Rivers flow, as do ocean currents. Any object placed in its way of passage is acted upon in some way. The object of my invention and those of Herschel (U.S. Pat. No. 873,435) and Mouton (U.S. Pat. No. 3,986,787) is to change hydraulic energy to mechanical energy and then to electrical energy, at the highest rate of exchange, This object being satisfactorily accomplished, all other aspects such as structure, process and location follow in a similar form as is followed in these two other inventions

A careful reading of Herschel's specification would make the methods he used to accomplish his object and differences in this embodiments method is very apparent. Herschel used two separate intake flows, each being sourced independently of the other. This enablement uses a single intake entry point to both provide an operating water supply and to accelerate its movement through its conduits, both for power and exhausting functions.

Energy in any of its forms relates to matter moving against other matter. In this instance, the matter, as a force, is moving water acting against the surfaces of a turbine with torque as mechanical energy ready to do work. The properties of flowing water will act against any object obstructing its pathway of passage and will alter its shape as it passes around, through or over any object. It simply continues onward. The following two inventions disclose variations, peculiar to each, as to their means for getting the most from the process of the transformation of energy form.

Reference is made to the River Turbine Patent (U.S. Pat. No. 3,986,787) of William J. Mouton, Jr. which was filed on Oct. 15, 1975. In that invention, the river turbine was based on the principal premise that, in order to remove kinetic energy from a moving mass of water without thereby reducing the mass rate of flow, it is necessary to provide an immediate downstream energy removal device, a region into which the mass of treated water is impelled to move, and simultaneously, the mainstream of water is impelled to move away from this region. The invention also employed novel configurations using accepted hydrodynamics principles, that took fullest possible advantage of the passing river stream. It utilized and recovered not only part of the energy in that portion of the river stream, it actually intercepted by this river turbine, but also utilized part of the energy of the mainstream to prepare a favorable downstream region for the discharge of the intercepted portion.

This invention does not create a vacuum by way of any induction action such as occurs when one stream of fluid flows against another, but accomplishes its objective by utilizing the negative pressure produced by the flow of water through an expanding conduit, with a considerable velocity head and at a low static head. The low efficiency of ejector devices, operated by the induction of one stream flowing against another, rendered them unsuitable in Mouton's design, for the discharge side for the purpose of increasing the power thereof

The objects of the Mouton invention were accomplished in a river current motor of the type made up of a primary nozzle with longitudinal horizontal axis, immersed in a river with axis parallel to the river current direction. This was designed to collect a portion of the river current from the mainstream of said current. The said primary nozzle had in sequence along its axis, an entrance end connected to a thorough going waterway, leading to a throat and then through a tailpiece to a discharge end. This was coaxially supported within the throat by an axial-entrance turbine wheel, to which it was the connected means for transferring mechanical rotational energy to external utilization means. The improvement comprised the following:

a. the flaring of the waterway from the throat to the discharge end to initiate and establish a gradually increasing cross section of the collected portion of the river current from the time it passed the turbine wheel, and
b. the flaring and structuring of the exterior of the primary nozzle to initiate and establish the formation of a diverging conical sheath of mainstream river current around the said collected portion, as that portion exited the discharge end of said primary nozzle.

It is noteworthy that Mouton commented at length on a common problem with river turbines, which his invention sought to solve. Mouton stated that “(S)tudy of this old art of river current motors reveals that they were all invented on the basis of a poor understanding of hydrodynamics, and a consequent false premise. The prior art seems to indicate that a river current motor, inserted into a river current, can remove part of the kinetic energy from the water and yet have the water proceed, without loss of velocity through the motor.”

Mouton continued that “such a situation is no more possible than is perpetual motion. What actually happened upon introduction of a prior art river current motor into a stream, was that the motor acted as an obstruction to the flow of the stream, and the obstruction resulted in a build-up of pressure upstream of the motor, by a local rise in the river level. As a consequence, part of the river flow that formerly went through the region of the motor, flowed instead around the motor. Since the path for flow of the water around the motor was not much longer or more tortuous than the path through the motor. Only a small fraction of the desired stream of water was passed through the motor, and this stream was moving more slowly than the main stream. Accordingly, little of the river's energy was extracted, and the prior art river current motors were extremely inefficient.”

Mouton thought that “little attention had been given in these prior art devices to obtaining smooth flow with least possible friction and turbulence from the mainstream, into the water wheel, and back into the mainstream. The turbines shown were highly inefficient, and many versions used ineffective screws or multiple wheels closely following one another. No attention was given to improving the downstream environment to ease the re-entrance of the portion of the current from which energy was supposed to have been extracted.”

My enablement acts to solve this dilemma that was perceptively raised by Mouton. It embodies very different hydrodynamic technology. This plant is a marine structure that extends from above the surface and downward to any desired depth and is held in place against the flow of such river by a tower structure anchored to the ocean bottom. Its water supply moves through conduits both for power function and exhausting function, as an accelerated free flowing stream into and out of the structure. It has a working floor inside, just as if it were located as part of a hydroelectric dam site, on some river in the United States.

All inventions trace their roots to prior art and although they may be new in object, feature, capability or ramifications, or in all of these areas, they share a lineage linking the past to the present. In the case of this enablement, the object is to capture the kinetic energy of an ocean stream, which is effectively a river at sea, and turn this vast force to perform useful work for mankind

My invention is an underwater turbine system, which operates in the vast reservoir of moving sea water in the oceans of the Earth. It embodies the best features of the gravity powered conventional power systems and run-of-the-river facilities and greatly improves on them. The Pelton turbine and direct drive electricity generation designed to operate on the wheel pit of my invention are all commercially available to include system design and installation.

The turbine, used in my invention, along with its direct drive generator and associated equipment, is commercially available, with either production or custom designed total systems adapted to the marine environment. The Pelton impulse generator has been used for many years. As a matter of information, the basic design was U.S. Pat. No. 233,692, Water Wheel, dated Oct. 26, 1880.

In reference to U.S. Pat. No. 7,291,936 B1, (Submersible Electrical Generating Power), this invention uses an entirely different method for generating electrical power. In contrast, my invention is a power plant with a wheel pit floor, using a seawater flow to drive an impulse turbine.

The diameters of the turbine rotors are limiting factors, so multiple units would have to be deployed over a large area to come anywhere near the capacity that an array of this enablement would produce. By contrast, the conventional style power plant features of my invention have an unlimited potential for volume energy output by manipulating its velocity and mass to control any desired output.

U.S. Pat. No. 7,768,145 (Power Generator and Turbine Unit) has a reactor turbine positioned within a Venturi shaped channel. A turbine with rotating blades drives a pump, which in turn, drives an above surface generator. The turbine units can be recovered for maintenance purposes. This invention also has an above water service component. My invention does not use a mechanically driven pump, nor does it have a Venturi shaped conduit. Instead, this enablement has cone/frustum entry ports with a straight pipe, only before its exit point, unlike the Venturi expanding pipe final section. The hydraulic dynamics of the referenced patent to this enablement are unlike each other. My invention has an impulse type wheel turbine, not a revolving blade reactor type turbine. It is an impulse turbine/generator means, except that its working environment is at sea. This technology has been well proven for over 150 years.

In reference to U.S. Pat. No. 7,132,758, Extracting Power From a Fluid Flow, filed May 19, 2003 by Geoffrey Rochester, this patent uses a stream of moving water through a Venturi to entrain a flow of air drawn from the atmosphere and acts as the prime mover for an air driven motor. The natural properties of the Venturi are well known prior art. My invention does not use the Venturi related to total immersion in sea water, as the means of both driving and exhausting functions of a turbine or as a method of my enablement. The same stream that my invention uses both drives the turbine and exhausts the spent water from its discharge. Each method has different objectives to accomplish. The impulse turbine has less mechanical complexity than the above referenced patent.

U.S. Pat. No. 7,768,145 (Power Generator and Turbine Unit) has a reactor turbine positioned within a Venturi shaped channel. A turbine with rotating blades drives a pump, which in turn, drives an above surface generator. The turbine units can be recovered for maintenance purposes. This invention also has an above water service component. My invention does not use a mechanically driven pump, nor does it have a Venturi shaped conduit. Instead, it has cone/frustum entry ports with a straight pipe only before its exit point, unlike the Venturi expanding pipe final section. The hydraulic dynamics are unlike each other. My invention has an impulse type wheel turbine, not a revolving blade reactor type turbine. It is an impulse turbine/generator means, except that its working environment is at sea. This technology has been well proven for over 150 years.

In reference to U.S. Pat. No. 7,132,758, Extracting Power From a Fluid Flow, filed May 19, 2003 by Geoffrey Rochester, this patent uses a stream of moving water through a Venturi to entrain a flow of air drawn from the atmosphere and acts as the prime mover for an air driven motor. The natural properties of the Venturi are well known prior art. My invention does not use the Venturi technology as the means of both driving and exhausting functions of a impulse type turbine. Each method has different objectives to accomplish. The impulse turbine also has less mechanical complexity than the above referenced patent.

With regard to US Patent Publication Number US 2006/0181086 A1 (Method and Apparatus for Generating Hydro-Electric Power); US Patent Publication Number U.S. Pat. No. 6,967,413 filed Jun. 14, 2004 (Method for Producing a Hydropower Plant); U.S. Pat. No. 4,464,080 (High Volume Tidal or Current Flow Harnessing System); U.S. Pat. No. 4,182,123 (Hydraulic Power Plant); U.S. Pat. No. 4,355,513 (Method for Producing Electricity from Thermal Sea Power); U.S. Pat. No. 7,466,035 (Transportable Hydro-Electric Generating System with Improved Water Pressure Enhancement Feature); U.S. Pat. No. 4,188,788 (Hydraulic Turbine System); U.S. Pat. No. 4,868,408 (Portable Water-Powered Electric Generator); U.S. Pat. No. 4,163,904 (Under Stream Turbine Plant); US Patent Publication 0140524 (Deployable Submarine-Hydro-Electric Generator For Sea Currents Energy Harvesting); U.S. Pat. No. 6,546,723 B1 (Hydropower Conversion System) and U.S. Pat. No. 8,002,499 (Waste Water Electrical Power Generating System), none of these Patents contain the following key features of my invention:

a. They do not have a stand-alone structure that rests firmly fixed to the seafloor, as if they were on an island surrounded by a vast pool of kinetic energy, with an above surface area suitable for doing any work or use that might be advantageous. This is quite like oil drilling or producer platform facilities used by the thousands around the world in the ocean or in large bodies of water;
b. They do not capture flowing ocean currents and the hydrostatic pressure of water at a depth in an intake conduit with regulating properties of velocity acceleration, volume ratio changes, and the ability to hold the stop the flow and hold it in a static state, further without any moving parts between the ocean and its availability for use at the cut off valve on the floor of the wheel pit, which;
c. Unlike the cited patents, this enablement consists of a structure within the ocean allowing a flowing ocean stream to flow through a conduit system. Most of my invention is located inside a water tight housing unit with the most essential components located on a wheel pit floor inside the building, to protect it from the elements and to facilitate ease of maintenance;
d. Unlike the cited patents, this enablement features an open-close valve, that when open, allows the flowing pressurize stream to flow into the Pelton Wheel Turbine component inside the water-tight structure;
e. Unlike the cited patents, this enablement utilizes the high velocity of the free flowing stream into which the spent water from the Pelton Wheel turbine is dumped or combined which assures the return of the total flow to the downstream ocean current. The velocity can readily exceed the velocity of the ocean current passing by the structure itself.

The advantage that this enablement has over all of the above referenced patents and those of a similar nature relates to the fact that this enablement is a hybrid, utilizing the best and most effective features of both a hydro-powered dam and a river turbine, both of which have a long history of successful operation, in an ocean or river environment. It is remarkable for its simplicity and expansion potential.

### BRIEF DESCRIPTION OF THE SEVERAL VIEWS OF THE DRAWINGS

FIG. 1: Offshore Hydro Power Facility

FIG. 1 is an isometric view of an off shore hydro-powered electricity generating plant. Its objective is to capture the kinetic energy for use as it transits the conduit system within the semi-submerged structure, an object which is held in opposition to the moving ocean stream. The prime mover for this system is a constantly flowing river, such as the Gulf Stream, which moves within the oceans. The structure is positioned within such vast bodies of kinetic energy, and standing firmly fixed while anchored to the ocean floor. The flow of kinetic energy through the system is by means of a conduit and a water tight compartment which houses electricity generating components. The conduits determine the flow characteristics of velocity, volume and hydrostatic head. The system parallels common aspects of land based hydro-power generating plants, i.e. penstock, drafting pipe and return to downstream flows as natural forces assure its movement through the structure. The discharged spent water thus rejoins the downstream current which has by-passed the outside exterior of the structure. The structure extracts kinetic energy which is transformed by means of a turbine and generating component. In every sense of the word, it is a complete hydro-power plant, a facility which extracts kinetic energy with an infinite supply of water.

FIG. 2: Off Shore Hydro Power Prime Mover

FIG. 2 is an isometric view of the partially submerged power plant component of the total system. The ocean current flows into the conduit system and out as a discharge flow downstream. The principal conduit/stream (as the entrant function) is a Jet Pump function that continuously flows thru the structure. A portion of the flow enters the Penstock conduit and terminates at a valve in the water tight structure. The flow transits the turbine/electricity generating component and then is discharged back into the jet stream flow via the draft tube conduit as spent water. Two valves regulate the flows thru and into the penstock and draft conduits; the space between the two valves is occupied by the impulse turbine which direct drives the electricity generating component. The Pelton water wheel turbine is driven by the prime mover flowing from the Penstock, through the work process and continuing without interruption of the flow onward.

FIG. 3: Off Shore Prime Mover & Generating System

FIG. 3 is an isometric view of the technological means for extracting kinetic energy from a moving body of sea water. The force (velocity, volume, & mass) is accelerated by means of cones/cylinders configured to regulate its properties, volume and velocity and apply its force to drive an electricity producing turbine. Thereafter, the sea water flow is sent onward without interruption downstream. The reality of this invention is that an otherwise always moving force from an infinite body of kinetic energy can be brought to a stop (partially or complete) and held in readiness for immediate use, in whatever quantity is desired.

FIGS. 4.1 and 4.2: Dimensional Analysis

FIGS. 4.1 & 4.2 are a method which provides Dimensional Analysis. These are dimensionless parameters for studying flow behavior before undertaking costly laboratory models. FIG. 4.1 establishes study parameters of the prime mover conduit system and FIG. 4.2 inputs the parameters into a mathematical model using dynamic hydraulic equations to predict theoretical results for the potential of the kinetic force moving through the embodiment and available for beneficial work in terms of electrical energy, kilowatt hours.

FIG. 5: Air Flow SuperCharger

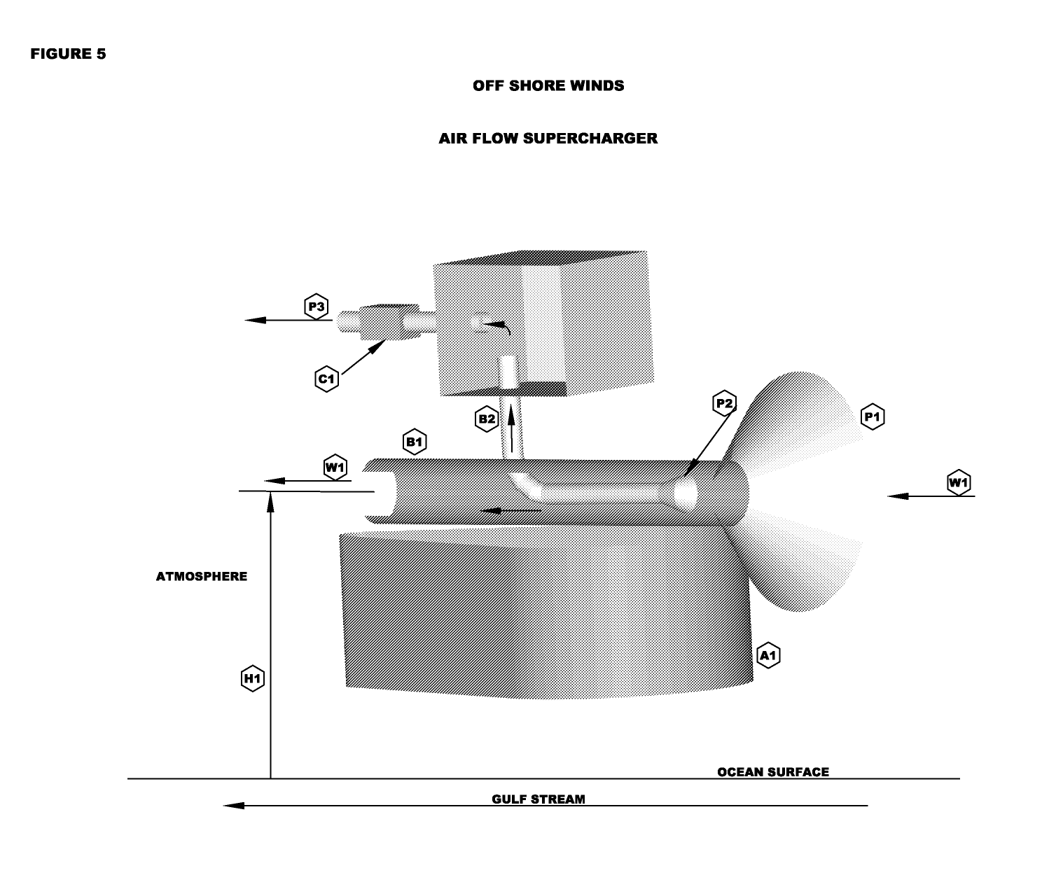

(FIG. 5) is an isometric view which depicts the prime mover as being wind as opposed to seawater and is shown as an alternate embodiment. This recognizes that water and air are both fluids and the laws of the universe are equally applicable. Bernoulli's equation works equally as well for determining the velocity of water or wind in a pipe or conduit. It follows that the conduit system of my invention for best use (Pelton Wheel), does work equally as well in the atmospheric environment as a prime mover when elevated at height in the atmosphere above the ocean surface as an Air Flow Supercharger which may act as an alternate or adjunct embodiment.

### DRAWINGS

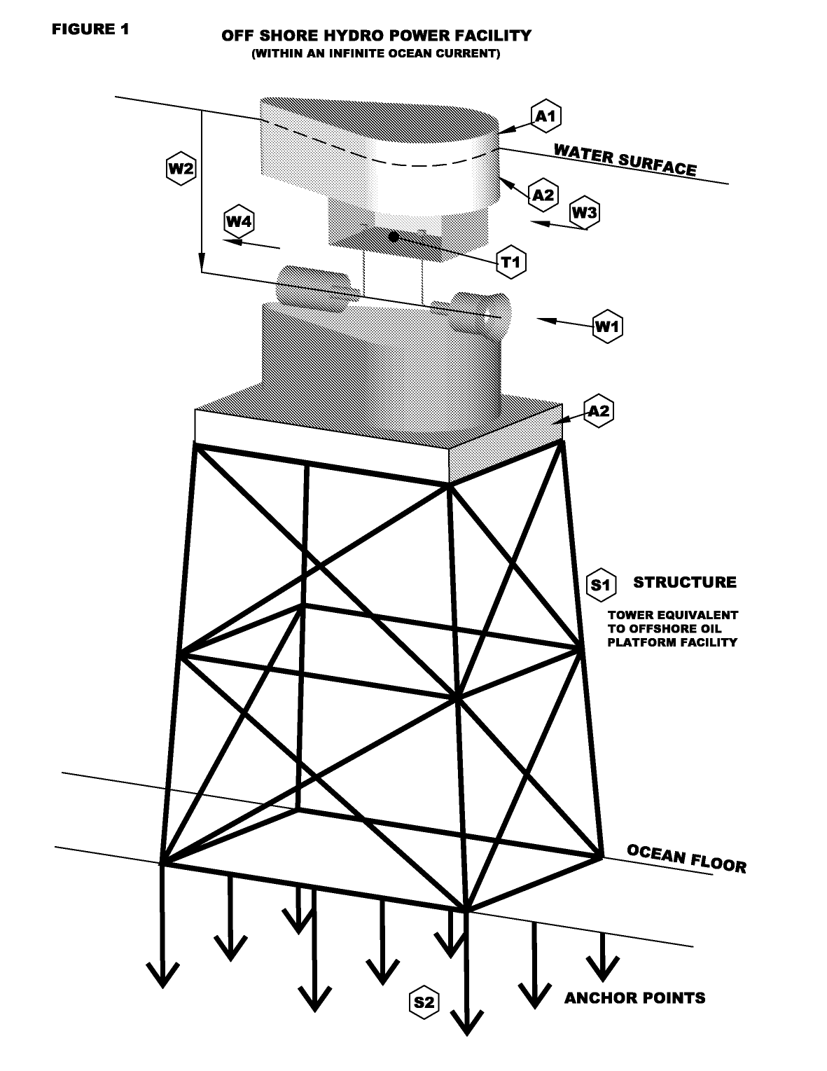

FIG. 1: OFF SHORE HYDRO POWER FACILITY (within infinite ocean currents)

(A1) is that part of the structure which resides above or on the surface of the body of water.

(A2) is that part of the structure within the body of water which supports the turbine wheel pit floor and general work support area;

(W1) is a pool of kinetic energy. It is a flowing water current, such as the Gulf Stream, which surrounds the watertight structure housing.

(W2) is the depth of water lying below the water surface and more particularly at the elevation point of the center line of the cone/frustum entry port.

(W3) is the flowing water current which entirely surrounds the structure housing the operating components and supporting structure extended/anchored on the sea floor.

(W4) is the downstream water flow which has passed the enablement by and is moving the water as it is discharged from the structure's exit point downstream

(T1) is the Pelton Wheel turbine & associated electricity generating components.

(S1) is a structure which extends downward to the ocean floor.

(S2) are the solid anchor points on the ocean floor at the base of the structure anchored on a fixed station.

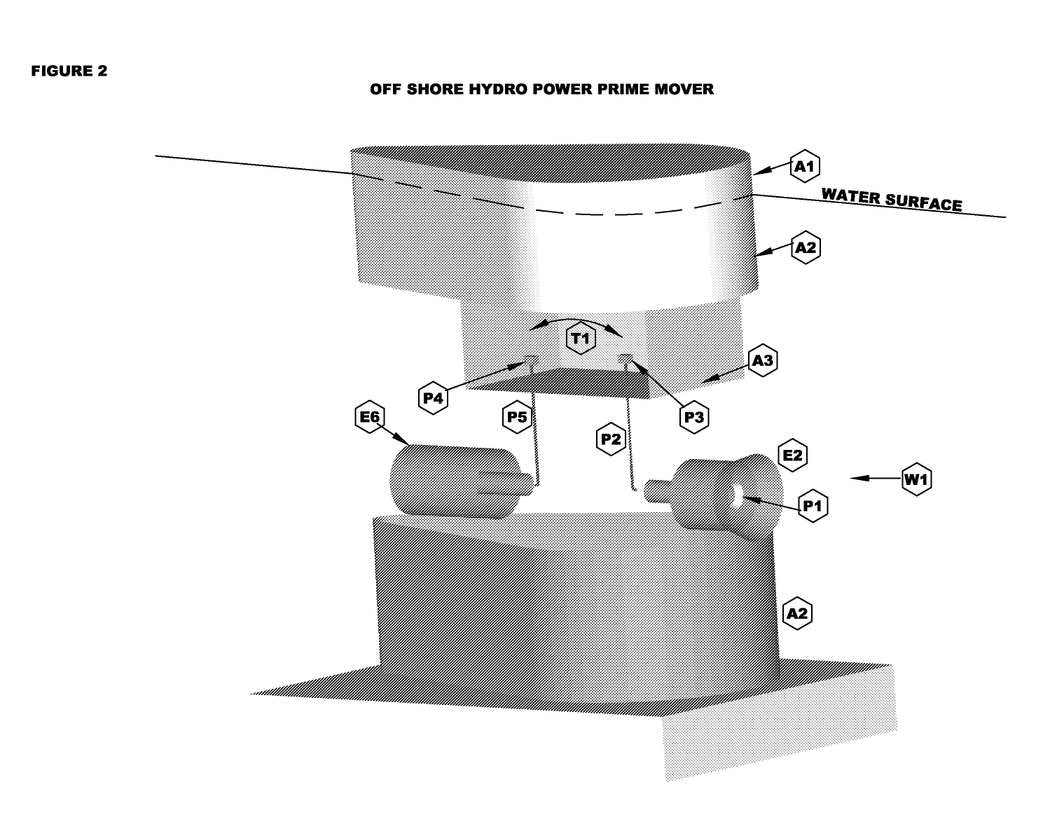

FIG. 2: Off Shore Hydro Power Prime Mover

(A1) is that part of the structure which resides above or on the surface of the body of water.

(A2) is that part of the structure within the body of water which supports the turbine wheel pit floor and general work support area.

(A3) is the wheel pit floor and general work support area.

(W1) is a pool of kinetic energy. It is a flowing water current, such as the Gulf Stream, which surrounds the watertight structure housing.

(E2) is the shrouded cone/frustrum entrance port for entry of the water mass as a motive force into a conduit/pipe of uniform dimension.

(P1) is the shrouded entrance, cones/frustum entry port from a portion of the moving high pressure water flow input from the jet pump.

(P2) is the conduit used as the prime mover power source for the turbine.

(P3 & P4) are manually operated cut off valves, located within the structure on the wheel pit floor to permit or deny entry or exit movement of the water supply thru the Pelton Wheel turbine and associated electric power generating package.

(T1) is the Pelton Wheel Turbine and associated electric power generating package.

(P5) is the draft conduit/pipe, which discharges the spent water from the turbine for combining at a juncture point with the jet pump stream for return to the Outflow.

(E6) is the exit port of the conduit system.

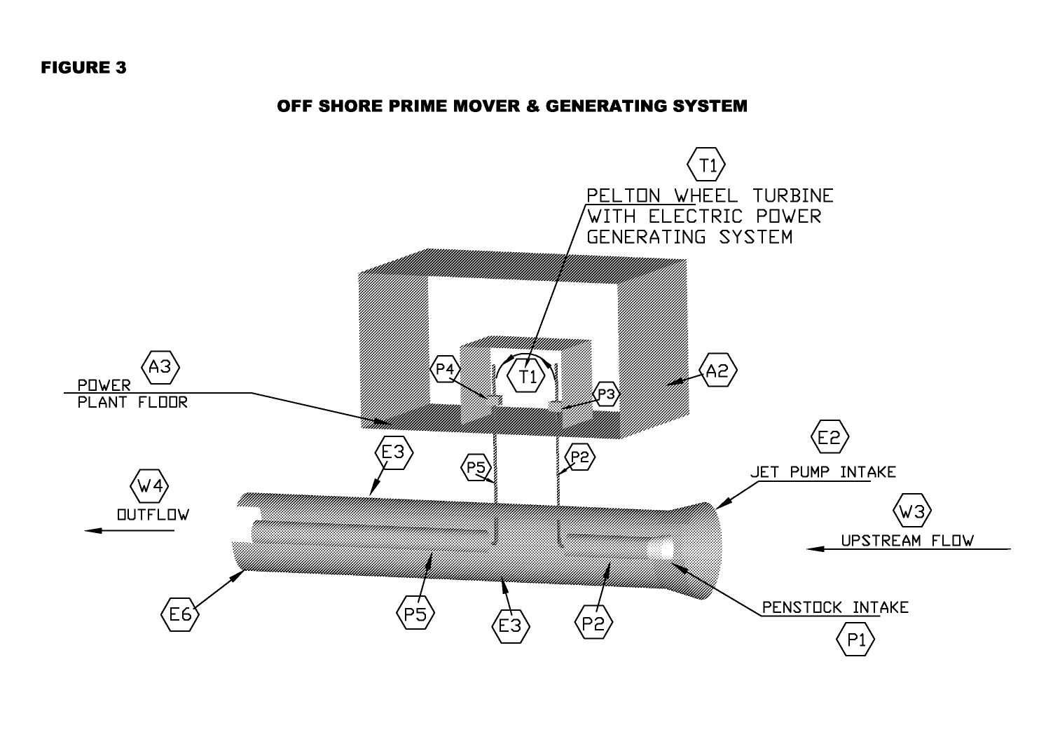

FIG. 3: Off Shore Prime Mover & Generating System

(A2) is that part of the structure within the body of water which supports the turbine wheel pit floor and general work support area;

(A3) is the wheel pit floor and general work support area.

(P1) is the shrouded entrance, cones/frustum entry port of the moving high pressure water flow input from the jet pump.

(P2) is the conduit used as the prime mover power source for the turbine.

(P3 & P4) are manually operated cut off valves, located within the structure on the wheel pit floor to permit or deny entry or exit movement of the water supply thru the Pelton Wheel turbine and associated electric power generating package.

(T1) is the Pelton Wheel Turbine and associated electric power generating package.

(P5) is the draft conduit/pipe, which discharges the spent water from the turbine for combining at a juncture point with the jet pump stream for return to the Outflow.

(W3) is the flowing water current which entirely surrounds the structure housing the operating components and supporting structure extended/anchored on the sea floor.

(E2) is the shrouded cone/frustrum entrance port for entry of the water mass as a motive force into a conduit/pipe of uniform dimension.

(E3) is the conduit/pipe of uniform dimension that runs from the shrouded cone/frustrum entrance from the structure to a downstream exit point.

(E6) is the exit port of the conduit system.

(W4) is the downstream water flow which has passed the enablement by and is moving the water. It is discharged from the structure's exit point downstream.

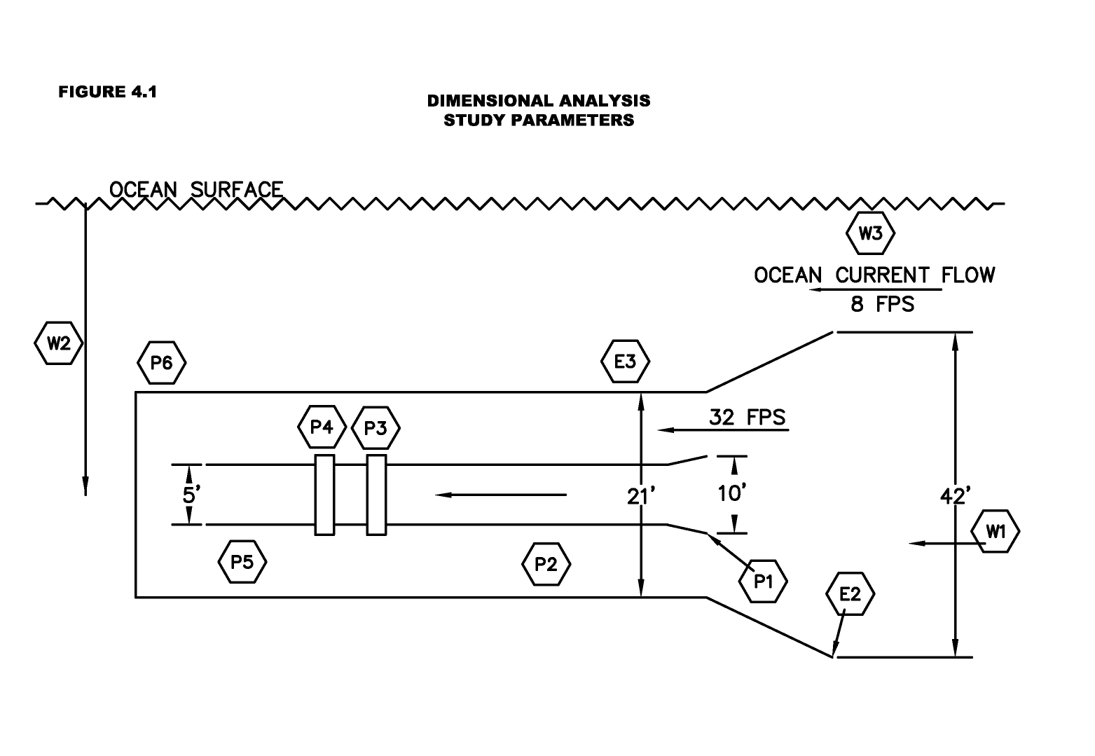

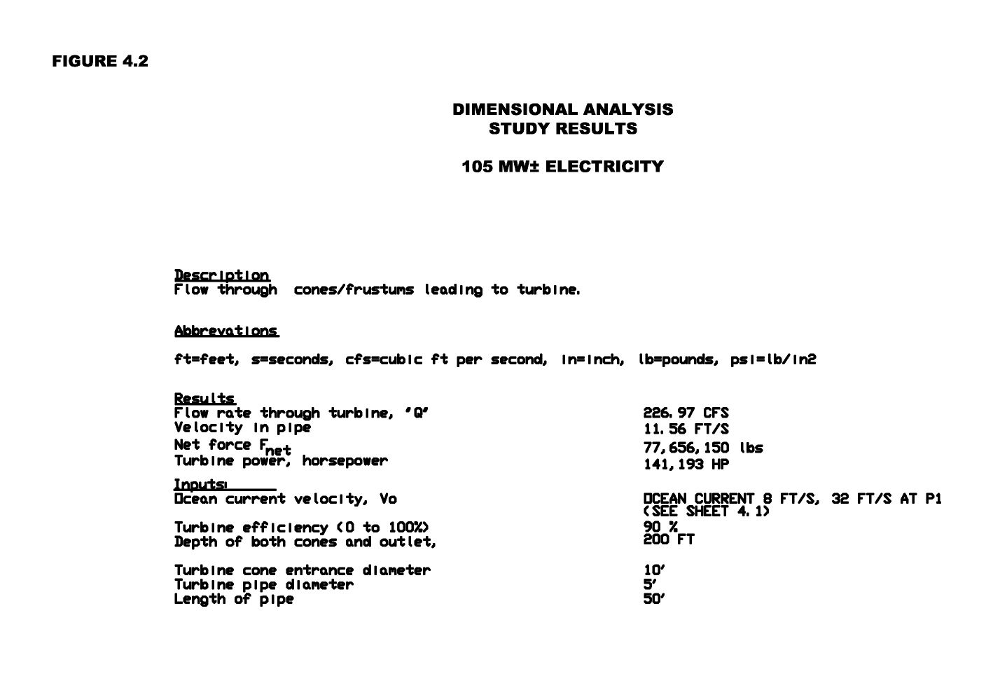

FIG. 4.1 and FIG. 4.2: Dimensional Analysis Study Parameters and Results

FIG. 4.2 displays the results of a kinetic water flow through the Pelton Water Wheel and associated electrical package. The end result is a theoretical power output of 141,193 horse power. The kinetic energy flow through the conduit system is shown on FIG. 4.1 in terms of conduit diameter sizes and velocity of flow movement as cubic feet per second. The parameters of the physical features in this example are flow volumes and the size of the conduit is show as follows:

(W3) is the ocean surface of a moving current, shown in the example as being 8 feet per second.

(W2) is the depth below the water surface, which in this example is 200 feet.

(E2) is the entrance of the cone/frustrum, which in this example, has a diameter of 42 feet at a flow of 8 feet per second.

(W1) is the ocean surface of a moving current, shown in the example as being 8 feet per second.

(E3) is the conduit pipe from the cone/frustrum base, which in this example, has a diameter of 21 feet at a flow of 32 feet per second.

(P1), the cone/frustrum, has a diameter of 10 feet and a flow of 32 feet per second in this example.

(P2) is the penstock, with a diameter of 5 feet.

(P3) and (P4) are the control valves which regulate the flow through T1, the Pelton Wheel Turbine.

(P5) is the discharge conduit.

(P6) is the exit point for the conduit system.

FIG. 5: Off Shore Winds: Air Flow Supercharger

(H1) is the atmosphere lying above the Gulf Stream and more particularly at the elevation point of the center line of the cone/frustum entry port.

(A1) is the supporting structure, as shown in FIG. 1.

(W1) is the ocean winds which flow almost continuously at high velocity rates over the ocean currents, and becomes a prime mover for the air supercharger, another embodiment whose object is to provide an on demand potential force.

(P1) is the cone/frustrum for the wind intake port.

(B1) is the conduit pipe from the cone/frustrum base.

(P2) is the cone/frustrum for the penstock entry port.

(B2) is a conduit of uniform size from the exit point of the cone/frustrum entry point, which terminates at a control valve.

(C1) is the control valve.

(P3) is the high pressure air flow output on demand from the system.

### FUNCTIONAL DESCRIPTION OF THE ENABLEMENT:

All References made herein for this invention are to items as identified on the FIGS. 1 through 3 of the drawings comprising the best use embodiment (Off Shore Hydro Power Facility) for extracting kinetic energy.

(A1) is that part of the structure which resides above or on the surface of the body of water;

(A2) is that part of the structure within the body of water which supports the turbine wheel pit floor and general work support area;

The power plant floor (A3) is the turbine wheel pit floor and work area. (W3) is a pool of kinetic energy. A flowing water current, such as the Gulf Stream, which surrounds the watertight structure housing (A1 and A2), the Pelton (A1, A2), Wheel turbine & electricity generating components and its structure (S1), which extends downward and sits solidly anchored on a fixed station at the ocean floor by anchor points (S2).

A continuously free flowing, high speed stream (W1) moves into and through the power plant conduit system, a portion of which feeds the penstock (P2) as the prime mover of the Pelton Wheel Turbine and associated electric power generating package (T1).

The kinetic force (velocity, area, mass) begins with cone/frustum entry port the free flow intake (E2), joining with (E3) as a jet pump to provide a portion of its free flowing, accelerated stream as an intake for the cone/frustum entry port (P1) penstock intake and penstock (P2), which then terminates at the manual cutoff valve (P3) in the power plant floor (A3). (P1) as a cone/frustum port for the penstock (P2), which accelerates the kinetic force it receives from the jet pump (E2 & E3) before it arrives at the manual cutoff valve (P3) on the power plant floor (A3) on which is situated the Pelton Wheel turbine (T1) in between the two manual cutoff valves (P3 & P4). (P3) is the terminal point for the penstock (P2). (P4) is the entry port for the draft conduit pipe (P5) which communicates with (E3), a conduit of uniform dimension, at which juncture the spent water is discharged by the turbine and combined with the continuously flowing stream of the jet pump (E2 & E3) for return to the outflow (W4). This is the complete hydraulic circuit of the prime mover, which is the heart of this invention. It begins with the ocean current (W1) and returns to the Outflow (W4), as a reservoir, unchanged in any manner or fashion.

The Pelton Wheel extraction process begins with nozzles directing forceful streams of water against a series of spoon shaped buckets mounted around the edge of the wheel. The direction of the water velocity changes to follow the contour of the bucket. The water is decelerated as it does a “u-turn” and flows out the other side of the bucket at low velocity. This impulse does work on the turbine. In this process, the water's momentum is transferred to the turbine which generates electricity. The turbine system is designed such that the water-jet velocity is twice the velocity of the bucket. A small percentage of the water's original kinetic energy remains in the water, this allows the bucket to be emptied and filled at the same rate, thus allowing the water flow to continue uninterrupted through the electricity generating process. The availability of kinetic energy from ocean currents and its transformation to electrical energy is a certainty; the driving force being the trade-winds and the rotation of the Earth on its axis. In every sense of the word, it is a complete hydro-power plant, a facility which extracts kinetic energy with an infinite supply of water.

(W3) is the flowing water current which entirely surrounds the structure housing the operating components and supporting structure extended/anchored on the sea floor.

References for this invention are to Dimensional Analysis (FIGS. 4.1 & 4.2), a method which provides dimensionless parameters for study flow behavior of the extraction means before undertaking costly laboratory models. FIG. 4.1 establishes study parameters of the prime mover conduit system and FIG. 4.2 inputs the parameters into a mathematical model using dynamic hydraulic equations to predict theoretical results for the potential of the kinetic force moving through the embodiment and available for beneficial work in terms of electrical energy, kilowatt hours. The input values and results of their input, as values for the analysis model, are as shown by FIGS. 4.1 and 4.2.

FIG. 5: Off Shore Winds: Air Flow Supercharger

References made herein for FIG. 5 is an alternative/adjunct enablement, for the best use embodiment.

The prime mover being wind as opposed to seawater, is shown as an alternate embodiment. This recognizes that water and air are both fluids and the laws of the universe are equally applicable. Bernoulli's equation works equally as well for determining the velocity of water or wind in a pipe or conduit. It follows that the conduit system of my invention for best use (Pelton Wheel), does work equally as well in the atmospheric environment as a prime mover when elevated at height in the atmosphere above the ocean surface as an Air Flow Supercharger.

The atmosphere (H1) lying above the Gulf Stream and more particularly at the elevation point of the center line of the cone/frustum entry port (P1) which combines with a pipe of uniform dimension (B1) that passes through the housing part of (A1), the complete structure (S1) resting on the ocean floor as shown in FIG. 1.

The ocean winds (W1) which flow almost continuously at high velocity rates over the ocean currents, become a prime mover for the air supercharger, another embodiment whose object is to provide an on demand potential force at (C1), a cut off valve which brings the kinetic flow to a complete stop when closed. (P3), when opened the flow is a kinetic force for useful work purposes.

The penstock is a combined assembly consisting of a cone/frustum (P1) and a conduit of uniform size (P2), beginning at the smaller end of (P1). The Penstock intakes the accelerated flow from (P1) and (B1) as the cone/frustum further accelerates the flow, then passes through (B2) to a termination point, which is a cutoff valve (C1). The flow when permitted to move through the opened valve, then is available to do beneficial work and afterwards, then to reenter the atmosphere as (P3).

### DETAILED DESCRIPTION OF THE INVENTION

FIG. 1 is the best use first embodiment.

All the Pelton Wheel turbine & associated electric power generating package (T1) needs is to be placed in the middle of the Gulf Stream and held in a watertight structure affixed to the ocean floor, on station in opposition to its always moving miles of kinetic energy, the ocean current. Its purpose is process the kinetic force and to extract this energy and to transform it to electricity.

Water with a fulcrum is in fact a Machine. The cone/frustum and smooth conduit arrangement with this invention is just that, a fulcrum. The stream's velocity is accelerated and regulated as it moves thru the system. The hydraulic circuit starts with the ocean stream and ends with ocean stream after having applied much of its force to the Pelton Wheel turbine and associated electric power generating package (T1).

This invention is a hydro-electrical power plant which operates in the ocean currents. It uses these natural forces of the earth as an infinite source of renewable energy. It does not consume matter. It transforms energy states. The components of the system and its off shore environment are:

a.) A body of flowing water;
b.) An impulse turbine placed at depth;
c.) A means to accelerate the velocity of the current and to regulate it;
d.) A direct drive electrical generator and transformer;
e.) A structure to house the turbine and to control the flow of water supply in an enclosing area to move thru the system, consisting of the components described herein to constitute an entire physical plant, the upper portion of which resides on and above the surface of the water, that is secured from moving from a fixed position in relation to the sea floor and that is oriented so the input points to face the incoming downstream current and in proper relationship to the offshore power grid electrical distribution system. Furthermore, it must be extended downward to the desired operating depth considering both current velocity and hydrostatic head.

It is an environmentally friendly way of generating electrical power. It changes raw water energy into a usable form as electricity. Capability is determined by turbine size and the effectiveness of conduit system to receive the seawater and accelerate process and discharge the spent seawater from the system.

This hydro-powered plant resides within a structure (as depicted) and submerged in a body of flowing water, at a depth with a fixed supporting structure that rests on the sea floor. The shrouded (cone/frustum) intake ports must be oriented so as to be directly facing the oncoming stream. The exit or discharge points for spent water discharge faces downstream of the structure.

The (T1) turbine buckets act as fulcrums with (W1) water pressure flowing across them acting as long levers to mechanically turn a (T1) direct drive axle. (T1) converts water pressure into mechanical energy by rotating a direct drive shaft. The axle, in turn, spins an electrical generator to produce an electron flow for voltage conversion by a transformer for onward transmission (not included herein) to an on shore power grid. The expelled spent water mass leaves the turbine via (P5) being in communication with (E3), equivalent to a tail-race conduit.

Prime Mover for the Power Plant. The kinetic force (velocity, area, mass) begins with cone/frustum entry port (E2) (free flow intake) joining with (E3) as a jet pump to provide a portion of its free flowing, accelerated stream as an intake for the cone/frustum entry ports (P1) (the penstock intake) and (P2) (the penstock), which then terminates at (P3) (manual cutoff valve) in the (A3) (power plant floor). (P1) as a cone/frustum port for the penstock (P2) also accelerates the kinetic force it receives from the Jet Pump (E2 & E3) before it arrives at the manual cutoff valve (P3) on the (power plant floor) (A3) on which is situated (T1) (the Pelton Wheel turbine) in between the two manual cutoff valves (P3 & P4). (P3) being the terminal point for the penstock (P2): (P4) being the entry port for (P5) (draft conduit/pipe) which communicates with (E3), a conduit of uniform dimension, at which juncture, the spent water is discharged by the turbine and combined with the effect of this enablement is to create an underwater hydro-electric dam, without consuming any fossil fuel or other type of non-renewable energy source and without the limitations, construction costs or adverse environmental or economic effects. There is no practical limit on the number of these generating plants, which can be placed in ocean currents or in rivers around the Earth, to provide unlimited energy for mankind for as long as the World exists.

What is claimed is:

1. A system comprising a watertight structure above and below the ocean surface at depth with a tower like supporting rig standing within the moving river of water and firmly affixed to the sea floor, with an interior conduit system in which a river of seawater, which is channeled through the housing as a kinetic stream of hydro power through its passageways, the housing portion with its conduit system being oriented toward the moving ocean stream, with a single entry port within the structure, permitting a continuous body of seawater to enter and transit the structure, a single entry point for the conduit system, which at least twice accelerates the flow velocities of the stream to be a Penstock prime mover, which drives at least one impulse type Pelton Wheel Turbine, said turbine with a direct drive power connection means for an electricity generating system, and together with a continuous free flowing stream moving simultaneously through the conduit system, to discharge all the seawater from a single exit port to rejoin the downstream ocean current flowing outside the housing portion of the structure.

2. The system in claim 1, wherein the shape of the structure, as a solid object impeding the flow of the body of water passing around it, is aerodynamically contoured as means of minimizing disturbances of the flow in its downstream movement along the external surfaces to facilitate the discharge of waste water from the structure's exit point.

3. The system in claim 1, wherein the conduit system is located within the structure and intakes the free flowing ocean stream at a cone/frustum port, as a means of accelerating the accepted flow which is then divided into two independent flows, the first flow entering a cone/frustum Penstock intake port which further accelerates the flow as a prime mover for the Felton Wheel Turbine, the other flow continues onward through the structure to a single exit port from the structure.

4. The system in claim 3, wherein the velocities of the water flowing through the initial and Penstock intake ports are increased by means of cones or frustums shaped entry points with the larger entry areas and smaller exit areas are to provide the force needed for the prime mover and the continuously flowing stream, which serves the discharge of all water, which includes the turbine discharge fraction, at a single the exit point of the housing structure.

5. The system in claim 3, wherein the conduit system provides a pathway and as it moves against the structure, it is permitted to enter a port and pass through the structure for exit and then to continue onward with, the stream which has passed by the external surfaces of the structure, said conduit system being formed and shaped in a manner of conduit segments to regulate intake volumes, change transit velocities and to include a separate conduit system inside itself, which is the Penstock going to operating floor where it terminates at a manual cutoff valve in the work space of the structure at the intake nozzle of the Pelton Wheel Turbine component, and also to provide for an intersection with another separate discharge conduit system as a tributary branch of the continuous stream, the branch being in communication and terminating in the working floor space at a cutoff valve in direct communication with the discharge port of the turbine.

6. The system of claim 1, wherein the above constitutes a marine based hydro powered electricity generating plant with an impulse turbine and direct drive electricity generator system whose prime mover is an inexhaustible ocean current whose force of kinetic energy, which is extracted from an ocean stream without encountering a single moving part between its transit and arrival, to terminate at a cutoff valve on the wheel pit floor, with ready on demand availability, to accomplish general purpose work routines, which includes the generation of electricity for distribution via a power grid and then in all cases, to discharge the spent sea water from an any work process passing through an manual open cut off valve within the conduit system, as a branching tributary to an intersection point on the primary conduit stream for return to the ocean stream from which it originated.

7. The system in claim 1, wherein the operating components are the means to accomplish the objects of the power plant with the preferred choice being a Pelton type turbine and direct drive connected electricity generating system, to include ancillary equipment, which is a commercially available as an installed production package or custom designed installation

8. The system in claim 1, wherein the entry ports for both the primary continuous stream conduit and its interior Penstock conduit are cone/frustum shaped ports of entry that intake any desired volumes of a fluid into the conduit system, with velocity changes in accordance with the law of continuity regarding flow of fluids, and the Penstock flow stream of fluids is stopped completely as a kinetic force at a terminating point by a closed cutoff valve, an energy force in readiness as a prime mover for beneficial work purposes.

9. The system in claim 1, wherein the system by means of conduits located within a housing on a tower like rig, attached to a stable solid surface, operates as a prime mover of fluids, more particularly within wind currents prevailing almost continuously at an elevated height in the atmosphere, a body of moving air (wind), will enter the properly oriented conduit system, in respect to its direction of flow, and by such means, the force will flow at accelerated velocities and move thru the Penstock
